(19) United States
(12) Patent Application Publication
(10) Pub. No.: US 2017/0291627 A1
(43) Pub. Date: Oct. 12, 2017

(54) Antibacterial Shopping Cart System

(71) Applicant: Donnette Grimmond-Schultz, Valley Stream, NY (US)

(72) Inventor: Donnette Grimmond-Schultz, Valley Stream, NY (US)

(21) Appl. No.: 15/093,478

(22) Filed: Apr. 7, 2016

(51) Int. Cl. B62B 5/06; B62B 3/14; B62B 5/00

(52) U.S. Cl. CPC B62B 5/069; B62B 5/0013; B62B 3/1448

(57) ABSTRACT

An antibacterial shopping cart system includes a shopping cart that has a handle, a storage section and a seat that is positioned within the storage section. A cover is removably positioned on the shopping cart such that the cover lines the storage section. The cover extends over the handle to inhibit bacteria from being transferred from the handle when the handle is gripped. The cover extends over the seat to inhibit bacteria from being transferred from the seat when the seat is sat upon.

### BACKGROUND OF THE DISCLOSURE

### Field of the Disclosure

The disclosure relates to antibacterial devices and more particularly pertains to a new antibacterial device for inhibiting bacteria from being transferred between a user and a shopping cart.

### Summary of the Disclosure

An embodiment of the disclosure meets the needs presented above by generally comprising a shopping cart that has handle, a storage section and a seat that is positioned within the storage section. A cover is removably positioned on the shopping cart such that the cover lines the storage section. The cover extends over the handle to inhibit bacteria from being transferred from the handle when the handle is gripped. The cover extends over the seat to inhibit bacteria from being transferred from the seat when the seat is sat upon.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of an antibacterial shopping cart system according to an embodiment of the disclosure.

FIG. 2 is a top view of an embodiment of the disclosure.

FIG. 3 is a bottom view of an embodiment of the disclosure.

FIG. 4 is a right side view of an embodiment of the disclosure.

FIG. 5 is a perspective in-use view of an embodiment of the disclosure.

### DESCRIPTION OF THE PREFERRED EMBODIMENT

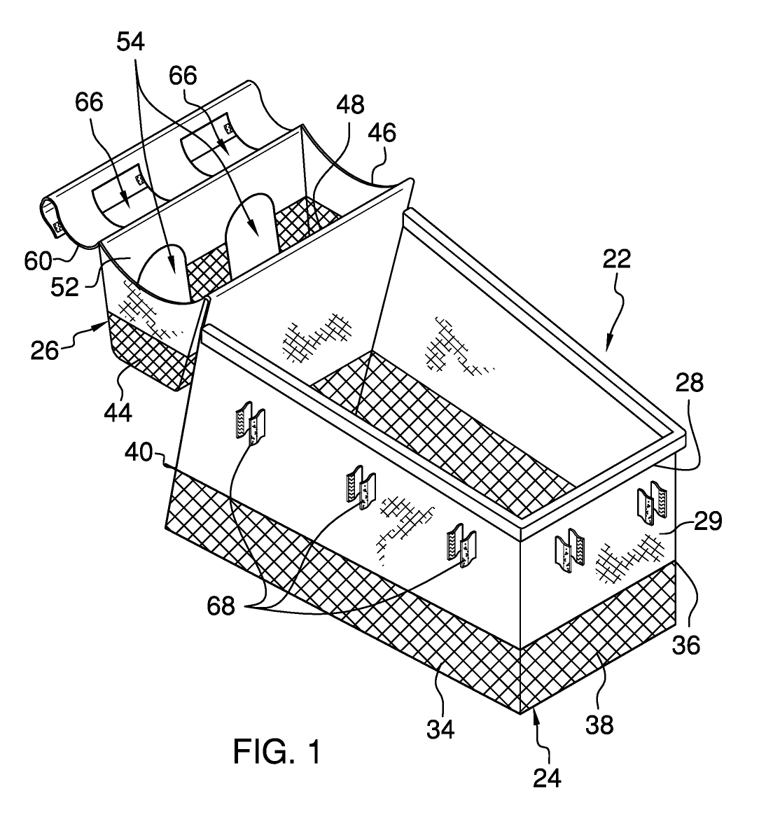

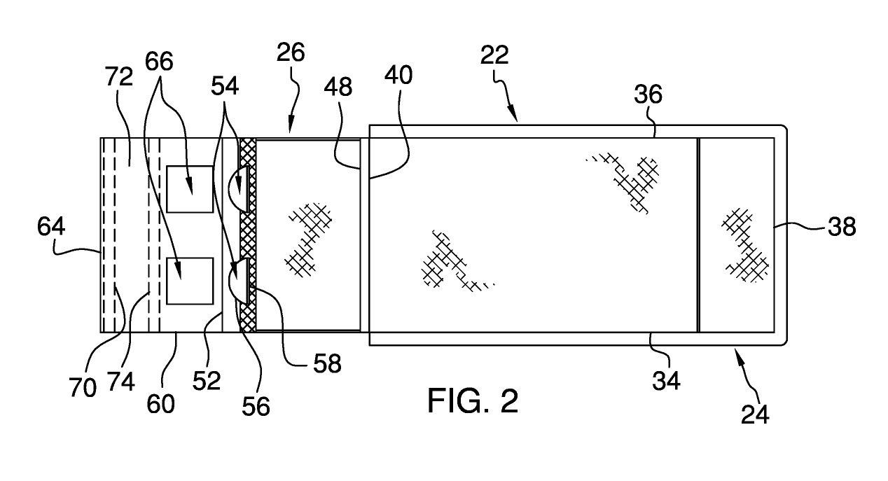

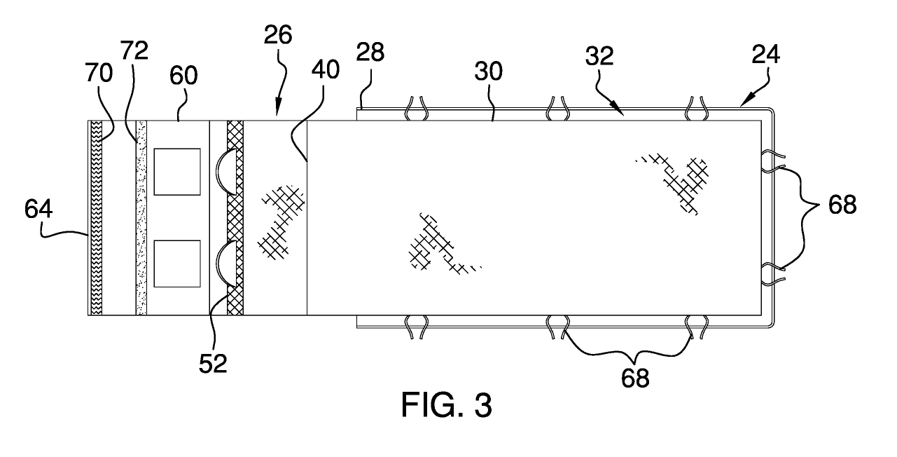

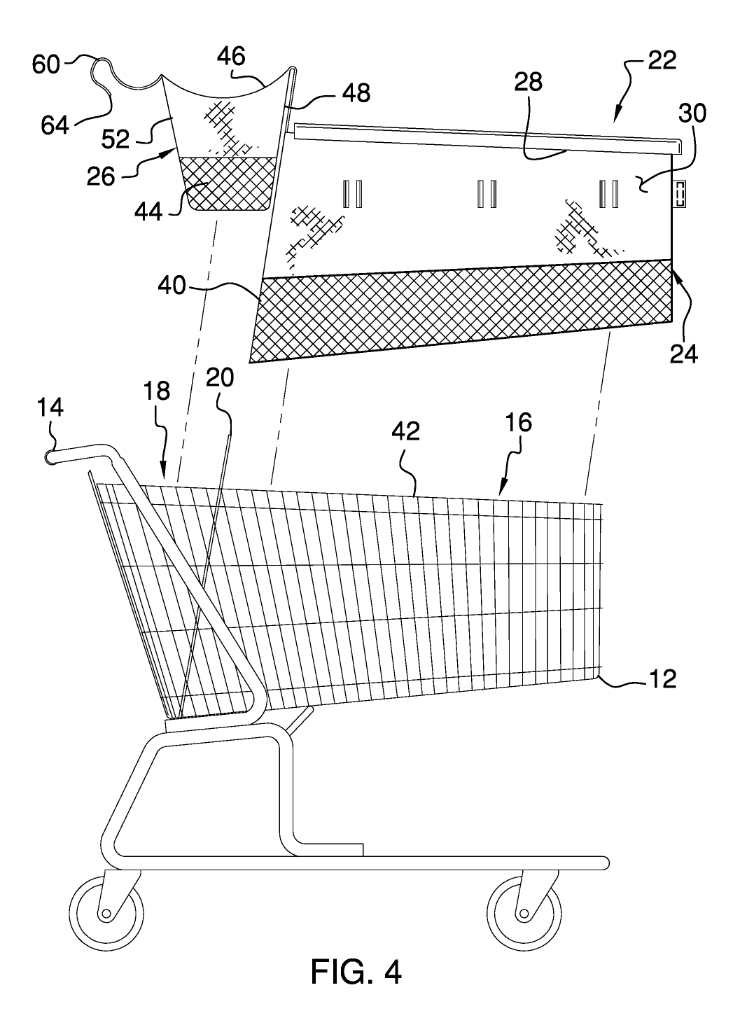

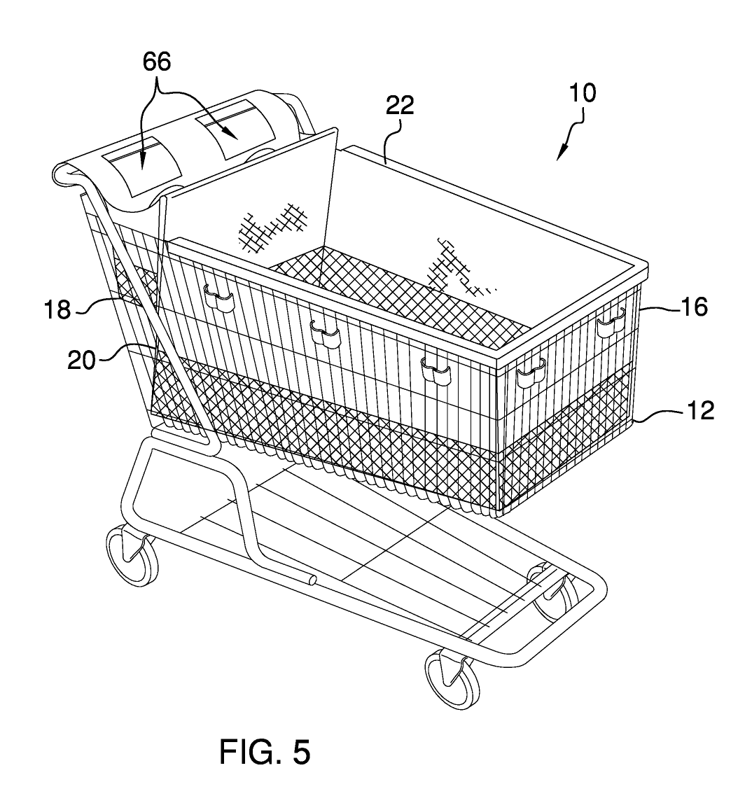

With reference now to the drawings, and in particular to FIGS. 1 through 5 thereof, a new antibacterial device embodying the principles and concepts of an embodiment of the disclosure and generally designated by the reference numeral 10 will be described.

As best illustrated in FIGS. 1 through 5, the antibacterial shopping cart system 10 generally comprises a shopping cart 12 that has a handle 14, a storage section 16 and a seat 18 that is positioned within the storage section 16. The seat 18 has a front wall 20 and the shopping cart 12 may comprise a shopping cart of any conventional design. A cover 22 is removably positioned on the shopping cart 12 such that the cover 22 lines the storage section 16. Thus, the cover 22 may have items positioned therein. The items may be items associated with grocery shopping or the like.

The cover 22 extends over the handle 14 when the cover is positioned on the shopping cart 12. Thus, the cover 22 inhibits bacteria from being transferred from the handle 14 when the handle 14 is gripped. The cover 22 extends over the seat 18 when the cover is positioned on the shopping cart 12. Thus, the cover 22 inhibits bacteria from being transferred from the seat 18 when the seat 18 is sat upon. The cover 22 may be comprised of a deformable material. Additionally, the cover 22 may be comprised of a fluid impermeable material thereby inhibiting bacteria from passing through the cover 22.

The cover 22 has a box portion 24 and a basket portion 26. The box portion 24 has a top edge 28 and an outer wall 29. The outer wall 29 is substantially comprised of a mesh material and the mesh material is translucent. The top edge 28 is rolled downwardly along an outer surface 30 of the box portion 24 to define a space 32 between the top edge 28 and the outer surface 30. The space 32 is coextensive with a first lateral side 34, a second lateral side 36 and a front side 38 of the box portion 24. A back side 40 of the box portion 24 extends upwardly beyond the first lateral side 34 and the second lateral side 36. The cover 22 is positioned on the shopping cart 12 having an upper edge 42 of the storage section 16 being positioned within the space 32. Thus, the cover 22 is positioned within the storage section 16 and the cover 22 completely covers the storage section 16.

The basket portion 26 has a perimeter wall 44 and the perimeter wall 44 has a topmost edge 46. The perimeter wall 44 is substantially comprised of a mesh material and the mesh material is translucent. The topmost edge 46 corresponding to a front side 48 of the basket portion 26 is coupled to the top edge 28 corresponding to the back side 40 of the box portion 24. The front side 48 of the basket portion 26 is spaced from the back side 40 of the box portion 24. The front wall 20 of the seat 18 is positioned between the basket portion 26 and the box portion 24 when the cover 22 is positioned on the shopping cart 12. Thus, the basket portion 26 is positioned within the seat 18 and the basket portion 26 completely covers the seat 18.

A rear side 52 of the basket portion 26 has a pair of leg openings 54 extending therethrough. The leg openings 54 are spaced apart from each other. Thus, each of the leg openings 54 may have a leg extended therethrough when the seat 18 is sat upon. Each of the leg openings 54 may have a first bounding edge 56 and a second bounding edge 58. The first bounding edge 56 may be concavely arcuate with respect to the second bounding edge 58. Thus, each of the leg openings 54 may have a semicircular shape.

A flap 60 is coupled to and extends away from the topmost edge 46 corresponding to the rear side 52 of the basket portion 26. The flap 60 has a distal edge 64 with respect to the basket portion 26. The flap 60 has a pair of hand openings 66 extending therethrough and the hand openings 66 are spaced apart from each other. Each of the hand openings 66 is positioned closer to the basket portion 26 than the distal edge 64.

The flap 60 is wrapped around the handle 14 when the cover 22 is positioned on the shopping cart 12. Thus, the flap 60 inhibits bacteria from being transferred from the handle 14 when the handle 14 is gripped. Each of the hand openings 66 may have a hand extended therethrough when the handle 14 is gripped thereby facilitating gripping the handle 14. Each of the hand openings 66 may have a rectangular shape.

A plurality of straps 68 is provided and each of the straps 68 is coupled to an outside surface 70 of the box portion 24. The straps 68 are spaced apart from each other and distributed around the box portion 24. Each of the straps 68 is positioned adjacent to the top edge 28 of the box portion 24. Each of the straps 68 engages the shopping cart 12 when the cover 22 is positioned within the shopping cart 12. Thus, each of the straps 68 inhibits the items from pulling the top edge 28 of the cover 22 into the shopping cart 12. Each of the straps 68 may comprise hook and loop fasteners or the like. Thus, each of the straps 68 is matable to themselves.

A first coupler 70 is coupled to a bottom surface 72 of the flap 60 and the first coupler 70 is coextensive with the distal edge 64 of the flap 60. A second coupler 74 is coupled to the bottom surface 72 and the second coupler 74 is spaced from the first coupler 70. The first coupler 70 engages the second coupler 74 when the flap 60 is wrapped around the handle 14. Thus, the flap 60 is retained on the handle 14. Each of the first coupler 70 and the second coupler 74 may comprise a hook and loop fastener or the like.

In use, the cover 22 is placed in the shopping cart 12. The box portion 24 is positioned in the storage section 16 and the basket portion 26 is positioned in the seat 18. The top edge 28 of the shopping cart 12 is positioned in the space 32. Each of the straps 68 is coupled to the shopping cart 12. The flap 60 is wrapped around the handle 14 and the handle 14 is gripped. A child may be positioned in the seat 18 and the child's legs may be extended through the leg openings 54. The basket portion 26 inhibits bacteria from being transferred between the seat 18 and the child. The items are positioned in the shopping cart 12 and the cover 22 is removed from the shopping cart 12 when the items are removed from the shopping cart 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An antibacterial shopping cart system comprising:
a shopping cart having handle, a storage section and a seat being positioned within said storage section;
a cover being removably positioned on said shopping cart such that said cover lines said storage section wherein said cover is configured to have items positioned therein, said cover extending over said handle wherein said cover is configured to inhibit bacteria from being transferred from said handle when said handle is gripped, said cover extending over said seat wherein said cover is configured to inhibit bacteria from being transferred from said seat when said seat is sat upon, said cover having a box portion, said box portion having a top edge, said top edge being rolled downwardly along an outer surface of said box portion to define a space between said top edge and said outer surface, said space being coextensive with a first lateral side, a second lateral side and a front side of said box portion, a back side of said box portion extending upwardly beyond said first lateral side and said second lateral side, said cover being positioned on said shopping cart having an upper edge of said storage section being positioned within said space such that said cover is positioned within said storage section, said cover completely covering said storage section;
a plurality of straps, each of said straps having horizontally aligned opposite ends being coupled to an outside surface of said box portion, said straps being spaced apart from each other and distributed around said box portion, each of said straps being positioned adjacent to said top edge of said box portion, each of said straps having a break oriented parallel to said opposite ends to facilitate engaging a vertically oriented support of said shopping cart when said cover is positioned within said shopping cart wherein each of said straps is configured to inhibit the items from pulling said top edge into said shopping cart, each of said straps comprising hook and loop fastener such that each strap is matable to itself for securing said strap to said shopping cart.

2. (canceled)

3. The system according to claim 2, wherein said cover has a basket portion, said basket portion having a perimeter wall, said perimeter wall having a topmost edge, said topmost edge corresponding to a front side of said basket portion being coupled to said top edge corresponding to a back side of said box portion, said front side of said basket portion being spaced from said back side of said box portion, a front wall of said seat being positioned between said basket portion and said box portion when said cover is positioned on said shopping cart such that said basket portion is positioned within said seat, said basket portion completely covering said seat.

4. The system according to claim 3, wherein a rear side of said basket portion has a pair of leg openings extending therethrough, said leg openings being spaced apart from each other wherein each of said leg openings is configured to have a leg extended therethrough when said seat is sat upon.

5. The system according to claim 1, wherein:
said cover has a basket portion, said basket portion having a topmost edge; and
a flap being coupled to and extending away from said topmost edge corresponding to a rear side of said basket portion, said flap having a distal edge with respect to said basket portion, said flap having a pair of hand openings extending therethrough, said hand openings being spaced apart from each other, each of said hand openings being positioned closer to said basket portion than said distal edge.

6. The system according to claim 5, wherein said flap is wrapped around said handle when said cover is positioned on said shopping cart wherein said flap is configured to inhibit bacteria from being transferred from said handle when said handle is gripped, each of said hand openings being configured to have a hand extended therethrough when said handle is gripped thereby facilitating gripping said handle.

7. The system according to claim 6, further comprising:
a first coupler being coupled to a bottom surface of said flap, said first coupler being coextensive with said distal edge; and
a second coupler being coupled to said bottom surface, said second coupler being spaced from said first coupler, said first coupler engaging said second coupler when said flap is wrapped around said handle thereby retaining said flap on said handle.

8. (canceled)

9. An antibacterial shopping cart system comprising:
a shopping cart having handle, a storage section and a seat being positioned within said storage section, said seat having a front wall; and
a cover being removably positioned on said shopping cart such that said cover lines said storage section wherein said cover is configured to have items positioned therein, said cover extending over said handle wherein said cover is configured to inhibit bacteria from being transferred from said handle when said handle is gripped, said cover extending over said seat wherein said cover is configured to inhibit bacteria from being transferred from said seat when said seat is sat upon, said cover having a box portion and a basket portion, said box portion having a top edge, said top edge being rolled downwardly along an outer surface of said box portion to define a space between said top edge and said outer surface, said space being coextensive with a first lateral side, a second lateral side and a front side of said box portion, a back side of said box portion extending upwardly beyond said first lateral side and said second lateral side, said cover being positioned on said shopping cart having an upper edge of said storage section being positioned within said space such that said cover is positioned within said storage section, said cover completely covering said storage section, said basket portion having a perimeter wall, said perimeter wall having a topmost edge, said topmost edge corresponding to a front side of said basket portion being coupled to said top edge corresponding to a back side of said box portion, said front side of said basket portion being spaced from said back side of said box portion, said front wall of said seat being positioned between said basket portion and said box portion when said cover is positioned on said shopping cart such that said basket portion is positioned within said seat, said basket portion completely covering said seat, a rear side of said basket portion having a pair of leg openings extending therethrough, said leg openings being spaced apart from each other wherein each of said leg openings is configured to have a leg extended therethrough when said seat is sat upon;
a flap being coupled to and extending away from said topmost edge corresponding to a rear side of said basket portion, said flap having a distal edge with respect to said basket portion, said flap having a pair of hand openings extending therethrough, said hand openings being spaced apart from each other, each of said hand openings being positioned closer to said basket portion than said distal edge, said flap being wrapped around said handle when said cover is positioned on said shopping cart wherein said flap is configured to inhibit bacteria from being transferred from said handle when said handle is gripped, each of said hand openings being configured to have a hand extended therethrough when said handle is gripped thereby facilitating gripping said handle;
a plurality of straps, each of said straps having horizontally aligned opposite ends being coupled to an outside surface of said box portion, said straps being spaced apart from each other and distributed around said box portion, each of said straps being positioned adjacent to said top edge of said box portion, each of said straps having a break oriented parallel to said opposite ends to facilitate engaging a vertically oriented support of said shopping cart when said cover is positioned within said shopping cart wherein each of said straps is configured to inhibit the items from pulling said top edge into said shopping cart, each of said straps comprising hook and loop fastener such that each strap is matable to itself for securing said strap to said shopping cart;
a first coupler being coupled to a bottom surface of said flap, said first coupler being coextensive with said distal edge; and
a second coupler being coupled to said bottom surface, said second coupler being spaced from said first coupler, said first coupler engaging said second coupler when said flap is wrapped around said handle thereby retaining said flap on said handle.
